(19) United States
(12) Patent Application Publication
(10) Pub. No.: US 2019/0299149 A1
(43) Pub. Date: Oct. 3, 2019

(54) Reactor and Process for Photochemical Degradation of Ethylene

(71) Applicants: ABSOGER, Les Barthes (FR); Institut National Polytechnique de Toulouse, Toulouse (FR); Universite Paul Sabatier Toulouse III, Toulouse (FR); Centre National de la Recherche Scientifique, Paris (FR)

(72) Inventors: Sylvain GERBAUD, Les Barthes (FR); Florence BENOIT-MARQUIE, Buzet sur Tarn (FR); Caroline ANDRIANTSIFERANA, Deyme (FR); Philippe DESTRAC, Toulouse (FR); Karine LOUBIERE, Toulouse (FR); Claire LAFOSSAS, Toulouse (FR); Henri DELMAS, Toulouse (FR); Marie-Hélène MANERO, Toulouse (FR)

(73) Assignees: ABSOGER, Les Barthes (FR); Institut National Polytechnique de Toulouse, Toulouse (FR); Universite Paul Sabatier Toulouse III, Toulouse (FR); Centre National de la Recherche Scientifique, Paris (FR)

(21) Appl. No.: 16/368,614

(22) Filed: Mar. 28, 2019

(30) Foreign Application Priority Data
Mar. 28, 2018 (EP) 18305351.1

(51) Int. Cl. B01D 53/00; B01J 19/12; B01J 4/00

(52) U.S. Cl. CPC B01D 53/007; A23B 7/152; B01J 4/001; B01J 19/123

(57) ABSTRACT

The present invention relates to a reactor and a process for photochemical degradation of ethylene that can be used with rooms for storing climacteric fruits and/or cut flowers.

### FIELD OF THE INVENTION

The present invention relates to a reactor and a process for photochemical degradation of ethylene in the far UV range that can be used with rooms for storing and preserving climacteric fruits, vegetables and/or cut flowers.

### BACKGROUND OF THE INVENTION

The ripening of a fruit corresponds to all of the biological and physiological changes that lead to the state of ripeness of a fruit, and that give it specific organoleptic properties, such as its texture, its color or its odor. Ripening is dependent on ethylene and is associated with an increase in the cell respiration of its tissues. For a climacteric fruit, a respiration peak is associated with a peak of ethylene production. For climacteric fruits, the peak of ethylene production is partly responsible for the ripening of the fruits. Climacteric fruits are therefore capable of ripening after having been picked. Thus, these fruits can be harvested green and ripen during the storage period. On the contrary, non-climacteric fruits must ripen on the plant and are not capable of independent ripening. The most well-known climacteric fruits are: banana, apple, pear, kiwi, tomato, melon, peach, apricot and avocado.

Adapting the French production of climacteric fruits to a globalized market and the increasing specialization of farms have led producers and shippers to develop systems for storing and preserving fruits, in order to spread out the annual supply to 10 months after the harvest. Preserving climacteric fruits is possible owing to the storage of these fruits in cold rooms (0-4° C.) and under a controlled atmosphere (AC: 2-3% O₂, 1-5% CO₂, ULO: 1.2-1.8% O₂, 1-2% CO₂ or XLO: 0.7-1% O₂, 0.6-1.2% CO₂) in order to slow down the respiration and therefore the ripening of the fruits, and to maintain the organoleptic properties of said fruits (firmness, acidity, coloration of the fruits). Climacteric fruits are chilled and placed in a controlled atmosphere as quickly as possible. The controlled gaseous atmosphere is obtained in a few days by immediate injection of nitrogen and extraction of the CO₂ as soon as the oxygen has been lowered to a few %.

The apple is a climacteric fruit, the ripening of which is accompanied by significant production of ethylene (which varies in function of the varieties, early and late). Apples intended for preservation are therefore harvested before the climacteric peak, from the start of the production of ethylene. At this time, the production of ethylene is very low but the fruit is capable of ripening after detachment from the tree, since this low level stimulates another system for producing ethylene, referred to as an auto-catalysis process, which will accelerate the ripening process. However, in the storage rooms, even if the respiration of the fruit is slowed down by the cold and the controlled atmosphere, and if the preclimacteric ethylene production is low, an accumulation of ethylene occurs due to the large amount of confined fruits. This accumulation of ethylene, which may reach several hundreds of ppm, accelerates the ripening of the apples through the auto-catalysis process, and promotes the appearance of certain fungal and physiological diseases. It is therefore essential to be able to correctly control the level of ethylene in the cold rooms.

In order to control the concentration of ethylene, various processes are used to date such as, for example, adsorption on activated carbon, thermal oxidation with or without catalysis by precious metals or oxidation by potassium permanganate present in the form of crystals or as impregnation on various materials. However these processes have a high operating, in particular energy, cost and the performance thereof is such that the concentration of ethylene in the controlled atmosphere is not always satisfactory. Furthermore, these processes must be stopped frequently since it is necessary to replace or regenerate the active compounds (adsorbent, catalyst or oxidant).

Other processes, such as the Smartfresh™ process, require chemical reagents applied directly to the fruits. These processes may be effective but are expensive, and the implementation thereof on all of the fruits stored remains difficult to achieve. Furthermore, these devices are not allowed in organic farming, and they may have unwanted side effects (browning of certain varieties of apples).

One process that consists in minimizing the O₂ content (<0.7%) of the controlled atmosphere of the storage room without inducing the fermentation of the fruit is currently commercialized. However, this process is expensive and requires a fine regulation and therefore an excellent leak tightness of the storage room which is not always what is possible in the case of old units.

Various processes for degrading the accumulated ethylene by catalytic processes have been developed and some are currently commercialized. However, these processes requiring the use of a catalyst have drawbacks which may vary as a function of the catalyst used. For example, some processes are highly energy-consuming since the catalyst must be heated continuously between 200° C. and 250° C. in order to be active, which has the consequence of heating the atmosphere drawn off from the storage room in order to treat it. This atmosphere must then be cooled to between 0° C. and 4° C. before being reintroduced into the storage room. Furthermore, after degradation of the ethylene by this type of catalytic process, the residual concentration of ethylene is not satisfactory for storing apples. Other catalytic processes involve photocatalysts such as TiO₂ but several technological constraints make the implementation thereof complex with insufficient efficiencies. There is therefore a need for a process for degrading the ethylene accumulated in a climacteric fruit storage room which is effective throughout the period of storing the fruits in the storage room and which is energetically economical.

Surprisingly, the Applicant has found an ethylenic degradation reactor that meets this need. According to a first aspect, the invention therefore relates to a reactor comprising:
a side wall having a cylindrical shape along an axis of revolution (Ox) and two end walls, the side wall and the end walls delimiting an internal reaction space,
a gas inlet port and a gas outlet port, and
a source of ultraviolet radiation in the internal reaction space, the reactor being characterized in that
   the source of ultraviolet radiation emits radiation in the far ultraviolet and has a variable power, in particular of from 10 W to 500 W.

This reactor makes it possible to degrade the ethylene of a gaseous atmosphere so that, on leaving the reactor, the concentration of ethylene in the gaseous atmosphere is less than 5 ppm, in particular less than 2 ppm, more particularly less than 1 ppm, and more particularly still less than 0.03 ppm. These very low ethylene concentration values are particularly suitable for preserving climacteric fruits, vegetables and cut flowers, in particular apples and kiwis.

Advantageously, these very low ethylene concentration values in the gaseous atmosphere leaving the reactor can be maintained continuously for around 1 year, i.e. throughout the storage period of the fruit in the storage room, and with no particular maintenance of the reactor of the invention.

Furthermore, thanks to the variable power of the source of ultraviolet radiation, it is possible to adjust the power of the radiation emitted in the far ultraviolet to the flow of ethylene introduced into or present in the internal reaction space of the reactor.

This adjustment makes it possible to reduce the energy consumption of the source of ultraviolet radiation to preserve the service life thereof.

This power adjustment also makes it possible to adjust the concentration of ethylene in the storage room and therefore to be able to control the ripening kinetics of the fruits, vegetables and/or cut flowers stored in this storage room.

Furthermore, the operation of the reactor according to the invention does not require heating, it is therefore not very energy consuming, and in particular less energy consuming than the operation of a catalysis reactor that must be heated permanently to the activation temperature of the catalyst.

According to a second aspect, another subject of the invention is a unit comprising the reactor according to the invention and a storage room, the storage room being fluidically connected to the gas inlet port and to the gas outlet port of the reactor according to the invention.

According to a third aspect, another subject of the invention is the use of a source of ultraviolet radiation emitting radiation in the far ultraviolet and having a variable power for the photochemical degradation.

According to a fourth aspect, another subject of the invention is a process for the degradation of ethylene comprising a step of photochemical degradation of ethylene using a source of ultraviolet radiation emitting radiation in the far ultraviolet and having a variable power, in particular of from 10 W to 500 W.

According to a fifth aspect, another subject of the invention is a process for photochemical treatment of a gaseous atmosphere of a closed chamber comprising ethylene, said process comprising at least one cycle comprising the following steps:
a) drawing off the gaseous atmosphere from the closed chamber,
b) treating the gaseous atmosphere to obtain a treated gaseous atmosphere,
c) introducing the treated gaseous atmosphere into the closed chamber,
   characterized in that the treatment step b) is a step of photochemical degradation of the ethylene carried out by a source of ultraviolet radiation emitting radiation in the far ultraviolet and having a variable power, in particular from 10 W to 500 W.

### FIGURES

FIG. 1 is an axonometric projection schematically illustrating an ethylene degradation reactor according to the present invention.

FIG. 2a is a projection schematically illustrating a cross section along the axis (Ox) of an orthogonal coordinate system (O, x, y, z) of the ethylene degradation reactor according to the present invention.

FIG. 2b is a cross section along the axis AN from FIG. 2a.

FIG. 3 is a projection schematically illustrating a cross section along the axis (Ox) of an orthogonal coordinate system (O, x, y, z) of an embodiment of the ethylene degradation reactor according to the present invention.

FIG. 4a is a projection schematically illustrating a cross section along the axis (Ox) of an orthogonal coordinate system (O, x, y, z) of the ethylene degradation reactor according to the present invention. For reasons of simplicity, the side wall of the reactor has a right circular cylindrical shape.

FIG. 4b is a cross section along the axis AN from FIG. 4a.

FIG. 5 is a graph illustrating the decrease over time of the concentration of ethylene in the gaseous atmosphere of a closed chamber, the gaseous atmosphere being treated in an ethylene degradation reactor according to the present invention.

FIG. 6 is a graph illustrating the decrease over time of the concentration of ethylene in the gaseous atmosphere of an industrial storage room, the gaseous atmosphere being treated in an ethylene degradation reactor according to the present invention.

### DETAILED DESCRIPTION

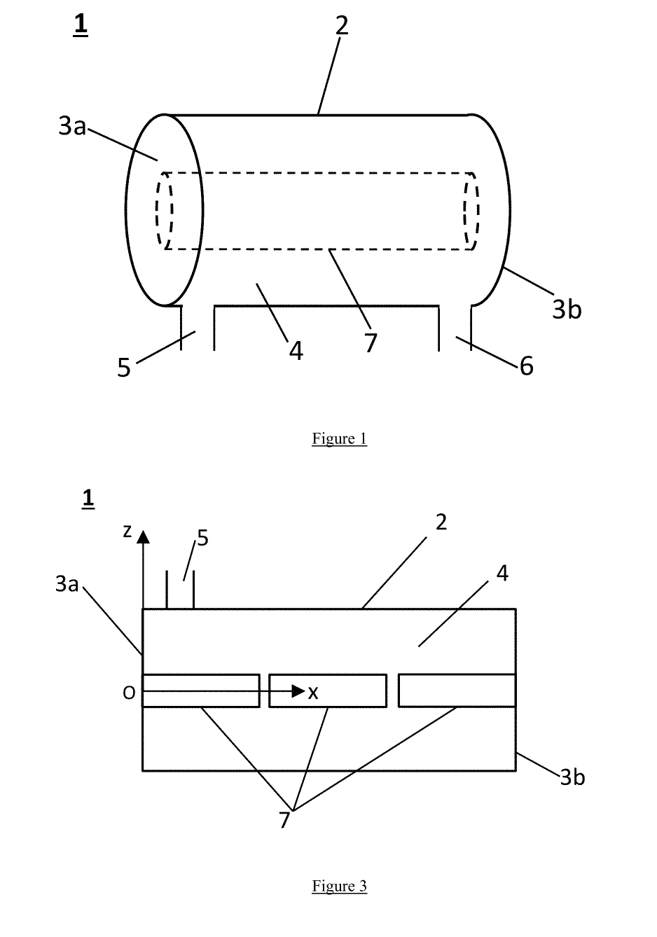

The present invention is described with reference to FIGS. 1 to 4b. For reasons of simplicity, the side wall of the reactor of the present invention is illustrated with a right circular cylindrical shape.

According to a first aspect, the invention relates to a reactor 1 comprising:
a side wall 2 having a cylindrical shape along an axis of revolution (Ox) and two end walls 3a and 3b, the side wall 2 and the end walls 3a and 3b delimiting an internal reaction space 4,
a gas inlet port 5 and a gas outlet port 6, and
a source of ultraviolet radiation 7 in the internal reaction space 4, characterized in that
   the source of ultraviolet radiation 7 emits radiation in the far ultraviolet and has a variable power, in particular from 10 W to 500 W.

Within the context of the present invention, the expression “wall having a cylindrical shape” is understood to mean a wall having the general shape of a cylinder, a cylinder being a surface created by a straight line which moves parallel to an axis of revolution (Ox), while bearing against two fixed planes. Typically, the cylinder may be a prism with a polygonal base such as a prism with a triangular base, a square base or rectangular base. The cylinder may also be a circular cylinder, in particular a straight circular cylinder characterized by a radius r and a height h. According to a specific embodiment, the cylinder is a circular cylinder so that the wall has a right circular cylindrical shape.

Within the context of the present invention, the expression “internal reaction space” is understood to mean the internal part of the reactor 1, i.e. the volume between the side wall 2 and the two end walls 3a and 3b.

Within the context of the present invention, the expression “gas inlet port” is understood to mean any element suitable for introducing a gaseous atmosphere into the internal reaction space 4 of the reactor 1.

Within the context of the present invention, the expression “gas outlet port” is understood to mean any element suitable for extracting a gaseous atmosphere from the internal reaction space 4 of the reactor 1.

Typically, the gas inlet port 5 is suitable for being connected to a gas duct. For example, the gas inlet port 5 may be a gas connector.

Typically, the gas outlet port 6 is suitable for being connected to a gas duct. For example, the gas outlet port 6 may be a gas connector.

Within the context of the present invention, the expression “gaseous atmosphere” is understood to mean a mixture comprising various gaseous compounds in particular comprising a mixture of nitrogen (N₂), carbon dioxide (CO₂), oxygen (O₂), water (H₂O) and ethylene (C₂H₄). Typically, the gaseous atmosphere may be a controlled gaseous atmosphere of a storage room comprising from 0.7% to 3% O₂, from 1% to 5% CO₂, from 80 to 100% relative humidity (RH) of H₂O, and less than 300 ppm of ethylene, the remainder being mainly nitrogen (N₂).

Within the context of the present invention, the expression “storage room” is understood to mean a chamber that may be closed and suitable for being leaktight and for storing fruits, such as climacteric fruits, vegetables and/or cut flowers at temperatures of from 0° C. to 15° C., in particular from 0° C. to 4° C. under a gaseous atmosphere.

Within the context of the present invention, the expression “climacteric fruit” is understood to mean a fruit for which the ripening is dependent on ethylene. The most well-known climacteric fruits are: banana, apple, pear, kiwi, tomato, melon, peach, apricot and avocado.

Within the context of the present invention, the expression “radiation emitted in the far ultraviolet (also denoted by far UV)” is understood to mean radiation having a spectral range between 100 nm and 200 nm.

Advantageously, the radiation emitted in the far UV enables the photochemical degradation of ethylene.

Within the context of the present invention, the expression “photochemical degradation” is understood to mean all of the chemical reactions that enable the decomposition of a chemical compound by light, i.e. by photolysis and/or by the reaction thereof with photoinduced species, such as radicals or ozone.

Without being tied to any one theory, the inventors are of the opinion that the photochemical degradation of ethylene is carried out by the photolysis of ethylene and by the oxidation of ethylene with ozone and photoinduced radicals, such as OH..

Compared to the catalytic process, the photochemical degradation is particularly advantageous since it does not require the use of a solid catalyst. The photochemical degradation is also less energy-consuming since it is not necessary to maintain this catalyst at its activation temperature.

Within the context of the present invention, the expression “source of ultraviolet radiation” is understood to mean a source emitting radiation in the far UV which may be of general cylindrical shape, i.e. it comprises an outer side wall having a cylindrical shape along an axis of revolution and two outer end walls and the material of which is transparent to the radiation emitted in the far UV.

Within the context of the present invention, the expression “power” is understood to mean the radiant power of the UV radiation emitted by the source of ultraviolet radiation 7.

Typically, the gaseous atmosphere comprising ethylene is introduced into the internal reaction space 4 of the reactor 1 via the gas inlet port 5. The gaseous atmosphere is then subjected to the radiation emitted in the far UV emitted by the source of ultraviolet radiation 7. The radiation emitted in the far UV enables the photochemical degradation of the ethylene of the gaseous atmosphere. The gaseous atmosphere thus treated is then extracted from the internal reaction space 4 of the reactor 1 via the gas outlet port 6.

Typically, on leaving the reactor 1, the concentration of ethylene in the treated gaseous atmosphere is less than 5 ppm, in particular less than 2 ppm, more particularly less than 1 ppm, and more particularly still less than 0.03 ppm. These low ethylene concentration values are particularly suitable for preserving climacteric fruits, vegetables and cut flowers, in particular apples and kiwis.

As also explained above, the use of the reactor 1 according to the invention is not very energy consuming, and in particular less energy consuming than a catalysis reactor, since it may be used without being heated and because the power of the source of ultraviolet radiation 7 is variable.

According to one embodiment, the reactor 1 according to the invention may further comprise a programmer suitable for varying the power emitted by the source of ultraviolet radiation 7.

According to one particular embodiment, illustrated by FIGS. 1 to 4, the side wall 2 may have a right cylindrical shape.

Typically, when the side wall 2 has a right circular cylindrical shape, its radius r is less than 500 mm, in particular from 10 mm to 250 mm, very particularly from 25 mm to 200 mm, and more particularly still from 50 mm to 100 mm, and its height h is less than 2000 mm, in particular from 500 mm to 750 mm, very particularly from 600 mm to 650 mm, and more particularly still from 615 mm to 625 mm.

According to one embodiment, the two ports 5 and 6 are positioned on the side wall 2.

According to one embodiment, one of the two ports is positioned on the side wall 2 and the other port is positioned on an end wall 3a or 3b.

According to one embodiment, the gas inlet port 5 and the gas outlet port 6 are positioned on the same end wall 3a or 3b.

According to one embodiment, one of the two ports is positioned on one of the two end walls and the other port is positioned on the other end wall.

According to one specific embodiment, the gas inlet port 5 and the gas outlet port 6 may be positioned at the opposite ends of the reactor 1.

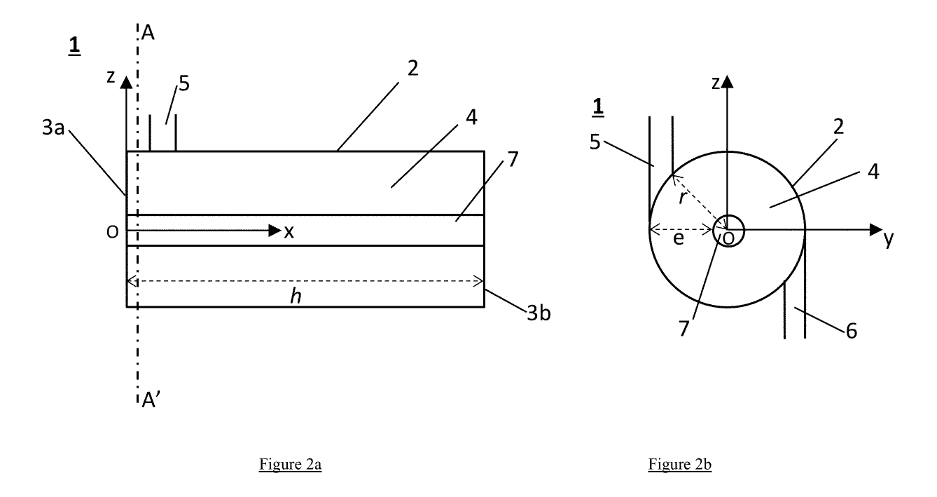

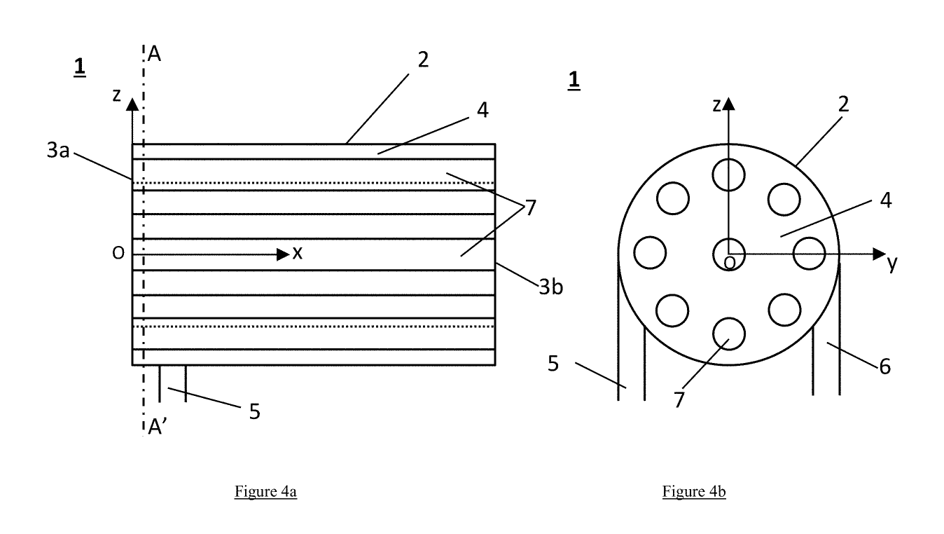

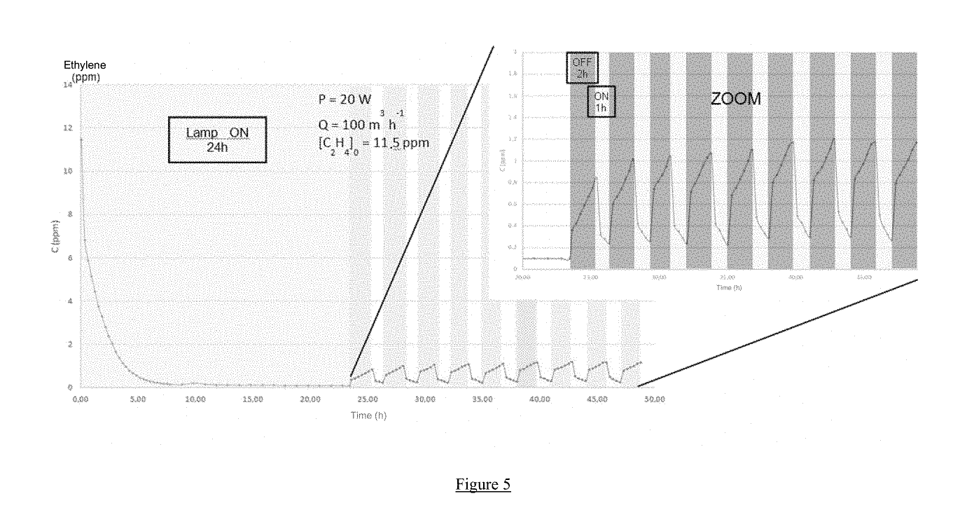

According to one embodiment, illustrated by FIGS. 2b and 4b, the gas inlet port 5 comprises a portion formed by a cylindrical duct, in particular a right circular cylindrical duct, a generatrix of which is tangent to a cross section of the side wall 2.

According to this embodiment, the gas inlet port 5 enables a tangential introduction of the gaseous atmosphere into the internal reaction space 4 thus creating a turbulent flow of the gaseous atmosphere in the internal reaction space 4.

Within the context of the present invention, the expression “turbulent flow” is understood to mean a turbulent flow characterized by a Reynolds number of greater than 5000 and by a non-zero turbulent intensity.

The turbulent flow makes it possible to maximize the turnover of the gaseous atmosphere close to the source of ultraviolet radiation 7 and to maximize the residence time of the gaseous atmosphere in the internal reaction space 4. Advantageously, this turbulent flow makes it possible to maximize the photochemical degradation of the ethylene.

A person skilled in the art will know how to adapt the dimensions of the portion formed by the cylindrical duct of the gas inlet port 5 and the flow rate of the gaseous atmosphere in order to maximize the turbulent flow in the internal reaction space 4.

According to one embodiment, illustrated by FIGS. 2b and 4b, the gas outlet port 6 may comprise a portion formed by a cylindrical duct, in particular a right circular cylindrical duct, a generatrix of which is tangent to a cross section of the side wall 2.

A gas outlet port 6 according to this embodiment makes it possible to maximize the turbulent flow of the gaseous atmosphere in the internal reaction space 4.

A person skilled in the art will know how to adapt the dimensions of the portion formed by the cylindrical duct of the gas outlet port 6 and the flow rates of the gaseous atmosphere in order to maximize the turbulent flow in the internal reaction space 4.

According to one embodiment, the reactor 1 may also comprise means for maximizing the turbulent flow in the internal reaction space 4.

Typically the reactor 1 may also comprise fastening means suitable for fastening the source of ultraviolet radiation 7 in the internal reaction space 4. Typically the end walls 3a and 3b of the reactor 1 comprise these fastening means.

According to one embodiment, illustrated in FIGS. 1 to 4b, the source of ultraviolet radiation 7 comprises an outer wall having a right circular cylindrical shape.

According to this embodiment, the radius of the outer wall of the source of ultraviolet radiation 7 is greater than 1 mm, in particular from 10 mm to 50 mm, very particularly from 20 mm to 25 mm, and its height is less than 2000 mm, in particular from 500 mm to 750 mm, very particularly from 600 mm to 650 mm, and more particularly still from 615 mm to 625 mm.

As illustrated in FIGS. 1 to 2b, when the side wall 2 has a right cylindrical shape and the outer wall of the source of ultraviolet radiation 7 has a right circular cylindrical shape, then their axes of revolution may be coincident. Advantageously, this makes it possible to homogenize the photochemical degradation of the ethylene.

Within the context of the present invention, the expression “gap” refers to the distance between the side wall 2 and the outer wall of the source of ultraviolet radiation 7 in the plane orthogonal to the axis of revolution (Ox). The gap “e” is illustrated in FIG. 2a.

According to one specific embodiment, the gap is from 1 mm to 499 mm, in particular from 10 mm to 250 mm, more particularly from 20 mm to 100 mm, very particularly 39 mm.

Advantageously, a gap within these value ranges makes it possible to maximize the absorption of the radiation emitted in the far UV within the reaction medium (the gaseous atmosphere present in the internal reaction space 4) and therefore to maximize the photochemical degradation of the ethylene.

According to one particular embodiment, the source of ultraviolet radiation 7 emits ultraviolet radiation, the spectral range of which is from 150 nm to 200 nm, very particularly from 160 nm to 180 nm, more particularly from 165 nm to 175 nm. According to one very particular embodiment, the source of ultraviolet radiation 7 emits ultraviolet radiation, the spectral range of which is only from 150 nm to 200 nm, very particularly only from 160 nm to 180 nm, more particularly only from 165 nm to 175 nm.

Typically a source of ultraviolet radiation 7 may emit continuous radiation in the far UV or emit radiation in the far UV over one or more spans of the spectral ranges mentioned above. A source of ultraviolet radiation 7 may also emit radiation in the far UV having one or more wavelengths of the spectral ranges mentioned above.

According to one very specific embodiment, the source of ultraviolet radiation 7 emits ultraviolet radiation, the wavelength of which is 172 nm.

The ethylene absorption spectrum has an absorption maximum at 170 nm. Advantageously, the spans of spectral range and wavelength mentioned above enable a photochemical degradation of the ethylene with a high quantum efficiency.

According to one embodiment, the variable power emitted by the source of ultraviolet radiation 7 is from 12 W to 100 W, in particular from 15 W to 50 W.

Advantageously, a power within the ranges indicated above makes it possible to obtain a good ratio between the flow of photochemically degraded ethylene and the energy cost of this photochemical degradation.

Ozone is a product generated by the photochemical degradation of ethylene when the gaseous atmosphere is subjected to radiation emitted in the far UV emitted by the source of ultraviolet radiation 7. Its presence may have a positive effect on the preservation of climacteric fruits, such as apples (sanitary effect on the spores present at the surface of the fruits), but may pose problems of safety and of damaging of equipment in the storage rooms. In order to control the concentration of ozone in the gaseous atmosphere extracted, the reactor 1 according to the invention may comprise an ozone elimination module fluidically connected to the gas outlet port 6.

Typically this ozone elimination module may comprise an adsorbent compound capable of decomposing ozone to oxygen such as a zeolite or activated carbon.

According to one particular embodiment, illustrated by FIG. 3, the reactor 1 may comprise n sources of ultraviolet radiation 7 positioned along the axis of revolution (Ox) of the reactor 1, n being an integer greater than or equal to 2, in particular from 2 to 50, very particularly from 2 to 10.

According to one particular embodiment, illustrated by FIGS. 4a and 4b, the reactor 1 may comprise m sources of ultraviolet radiation 7 in a plane (O, y, z) orthogonal to the axis of revolution (Ox), m being an integer greater than or equal to 2, in particular from 2 to 50, very particularly from 2 to 10.

Multiplying the sources of ultraviolet radiation 7 in the internal reaction space 4 makes it possible to adapt the dimensions of the reactor 1 to the volume of gaseous atmosphere to be treated.

According to this embodiment, the distance between two of the m sources of ultraviolet radiation 7 is less than or equal to two times the gap, e.

Advantageously, such a distance between two of the m sources of ultraviolet radiation 7 makes it possible to maximize the use of the radiation emitted in the far UV and therefore to maximize the photochemical degradation of ethylene.

Typically, the distance between two of the m sources of ultraviolet radiation 7 is from 2 mm to 200 mm, in particular from 20 mm to 150 mm, more particularly from 40 mm to 100 mm, very particularly 78 mm.

The use of the reactor 1 according to the invention is particularly advantageous when the reactor 1 according to the invention is fluidically connected to a storage room.

Thus, according to a second aspect, another subject of the invention is a unit comprising the reactor 1 as described above and a storage room, the storage room being fluidically connected to the gas inlet port 5 and to the gas outlet port 6 of the reactor 1.

Typically, the reactor 1 is present outside of the storage room. The reactor 1 may also be present in the storage room. This makes it possible to reduce the space requirement of the unit, for example on a boat or in an airplane transporting the fruits, such as climacteric fruits, vegetables and cut flowers.

The storage room and the reactor 1 operate in a closed loop. Thus, the controlled gaseous atmosphere of the storage room comprising ethylene is drawn off continuously or sequentially from the storage room in order to be introduced into the internal reaction space 4 of the reactor 1 via the gas inlet port 5. In the internal reaction space 4, the controlled gaseous atmosphere is subjected to the radiation emitted in the far UV emitted by the source of ultraviolet radiation 7. Thanks to the radiation emitted in the far UV, the ethylene of the controlled gaseous atmosphere is degraded photochemically. The controlled gaseous atmosphere thus treated is then extracted from the internal reaction space 4 of the reactor 1 via the gas outlet port 6 and is reintroduced continuously or sequentially into the storage room. On leaving the reactor 1, the concentration of ethylene in the treated controlled gaseous atmosphere is typically less than 5 ppm, in particular less than 2 ppm, more particularly less than 1 ppm, and more particularly still less than 0.03 ppm.

As explained below, this closed-loop operation makes it possible to reduce the concentration of ethylene in the controlled gaseous atmosphere of the storage room down to a threshold value then to stabilize it at this threshold value even though ethylene may be produced regularly by the fruits and/or the cut flowers present in the storage room.

After introducing the fruits, vegetables and/or cut flowers to be stored into the storage room and closing the storage room, the controlled gaseous atmosphere of the storage room is obtained by lowering the oxygen (O₂) content then by immediate injection of nitrogen (N₂) and extraction of the CO₂. Typically, the initial concentration of ethylene in the controlled gaseous atmosphere of the storage room is less than 300 ppm.

The photochemical degradation of the ethylene of the controlled gaseous atmosphere in the internal space 4 of the reactor 1 will make it possible to lower the concentration of ethylene in the controlled gaseous atmosphere of the storage room from the initial value to the threshold value. Then, once the threshold value is attained, the concentration of ethylene in the controlled gaseous atmosphere of the storage room will stabilize at the threshold value thanks to the photochemical degradation of the ethylene of the controlled gaseous atmosphere in the internal space 4 of the reactor 1.

The threshold value is typically less than 5 ppm, in particular less than 2 ppm, more particularly less than 1 ppm, and more particularly still less than 0.03 ppm. These low values are particularly suitable for preserving climacteric fruits, vegetables and cut flowers, in particular apples and kiwis. Consequently, the unit according to the invention is particularly suitable for preserving climacteric fruits, vegetables and cut flowers, in particular apples and kiwis.

Advantageously, the unit according to the invention is not very energy-consuming since, as was also explained above, the variable power of the source of ultraviolet radiation 7 may be adjusted to the increasingly low concentration of ethylene in the controlled gaseous atmosphere of the storage room, and the reactor 1 according to the invention may be used without being heated.

Typically, the unit comprises a means suitable for circulating the controlled gaseous atmosphere between the storage room and the reactor 1. Typically, this means may be a fan, a booster or a turbine. Typically, this means is fluidically connected to the storage room and to the gas inlet port 5 or to the gas outlet port 6.

The flow rate through the reactor 1 governs the turnover rate of the atmosphere of the storage room.

If the reactor 1 according to the invention comprises the ozone elimination module described above, then this module is fluidically connected to the gas outlet port 6 and to the storage room.

This elimination module makes it possible to control the concentration of ozone in the portion of gaseous atmosphere extracted from the internal reaction space 4 of the reactor 1 which is reintroduced into the storage room. This makes it possible to benefit from the advantages of the presence of ozone (sanitary effect on the spores present at the surface of the fruits) without having the drawbacks thereof (problems of safety and of damaging of equipment in the storage rooms).

Typically, the concentration of ozone in the gaseous atmosphere extracted from the internal reaction space 4 of the reactor 1 and reintroduced into the storage room is less than 2 ppm, in particular less than 1 ppm, very particularly from 0.2 ppm to 0.5 ppm.

According to a third aspect, another subject of the invention is the use of a source of ultraviolet radiation emitting radiation in the far ultraviolet and having a variable power for the photochemical degradation.

The source of ultraviolet radiation is as described above in connection with the source of ultraviolet radiation 7 of the reactor 1 according to the first aspect of the invention then also in the unit described above.

Thanks to the variable power of the source of ultraviolet radiation, it is possible to adjust the power of the radiation emitted in the far UV to the amount of ethylene to be degraded.

As explained above, this adjustment makes it possible to reduce the energy consumption of the source of ultraviolet radiation and preserve the service life thereof. The process according to the invention is therefore not very energy consuming, and in particular less energy consuming than a catalytic process. This power adjustment also makes it possible to adjust the concentration of ethylene in a storage room and therefore to be able to control the ripening kinetics of the fruits, vegetables and/or cut flowers stored in this storage room.

The ethylene degradation process according to the invention may be carried out in a gaseous atmosphere comprising less than 300 ppm of ethylene.

Typically, the concentration of ethylene in the gaseous atmosphere that has undergone the ethylene degradation process is less than 5 ppm, in particular less than 2 ppm, more particularly less than 1 ppm, and more particularly still less than 0.03 ppm. These low ethylene concentration values are particularly suitable for preserving climacteric fruits, vegetables and cut flowers, in particular apples and kiwis.

According to a fourth aspect, another subject of the invention is a process for the degradation of ethylene comprising a step of photochemical degradation of ethylene using a source of ultraviolet radiation that emits radiation in the far ultraviolet and that has a variable power, in particular from 10 W to 500 W.

The source of ultraviolet radiation is as described above in connection with the source of ultraviolet radiation 7 of the reactor 1 according to the first aspect of the invention then also in the unit described above.

Thanks to the variable power of the source of ultraviolet radiation, it is possible to adjust the power of the radiation emitted in the far UV to the amount of ethylene to be degraded.

As explained above, this adjustment makes it possible to reduce the energy consumption of the source of ultraviolet radiation and preserve the service life thereof. The process according to the invention is therefore not very energy consuming, and in particular less energy consuming than a catalytic process. This power adjustment also makes it possible to adjust the concentration of ethylene in a storage room and therefore to be able to control the ripening kinetics of the fruits, vegetables and/or cut flowers stored in this storage room.

The ethylene degradation process according to the invention may be carried out in a gaseous atmosphere comprising less than 300 ppm of ethylene.

Typically, the concentration of ethylene in the gaseous atmosphere that has undergone the ethylene degradation process is less than 5 ppm, in particular less than 2 ppm, more particularly less than 1 ppm, and more particularly still less than 0.03 ppm. These low ethylene concentration values are particularly suitable for preserving climacteric fruits, vegetables and cut flowers, in particular apples and kiwis.

According to a fifth aspect, another subject of the invention is a process for photochemical treatment of a gaseous atmosphere of a closed chamber comprising ethylene, said process comprising at least one cycle comprising the following steps:
a) drawing off the gaseous atmosphere from the closed chamber, such as a storage room, in particular a room for storing for climacteric fruits, vegetables and/or cut flowers,
b) treating the gaseous atmosphere to obtain a treated gaseous atmosphere,
c) introducing the treated gaseous atmosphere into the closed chamber,
   characterized in that the treatment step b) is a step of photochemical degradation of the ethylene carried out by a source of ultraviolet radiation emitting radiation in the far ultraviolet and having a variable power, in particular from 10 W to 500 W.

The source of ultraviolet radiation is as described above in connection with the source of ultraviolet radiation 7 of the reactor 1 according to the first aspect of the invention.

As claimed above, thanks to the variable power of the source of ultraviolet radiation that makes it possible to adjust the power of the radiation emitted in the far UV to the amount of ethylene to be degraded, the photochemical treatment process according to the invention is not very energy consuming, and in particular less energy consuming than a catalytic process. Furthermore, this power adjustment makes it possible to adjust the concentration of ethylene in the storage room and therefore to be able to control the ripening kinetics of the fruits, vegetables or cut flowers stored in this storage room.

Typically, when the closed chamber is a storage room and when climacteric fruits are stored therein, then ethylene may be produced continuously by said climacteric fruits.

This treatment process according to the invention may be carried out in a gaseous atmosphere comprising less than 300 ppm of ethylene.

During step a), the gaseous atmosphere comprising ethylene is drawn off continuously or sequentially from the closed chamber in order to be treated during step b).

During the treatment step b), the gaseous atmosphere is subjected to the radiation emitted in the far UV emitted by the source of ultraviolet radiation. Thanks to the radiation emitted in the far UV, the ethylene of the gaseous atmosphere is degraded photochemically. Typically, after step b), the concentration of ethylene in the treated gaseous atmosphere is less than 5 ppm, in particular less than 2 ppm, more particularly less than 1 ppm, and more particularly still less than 0.03 ppm. These low ethylene concentration values are particularly suitable for preserving climacteric fruits and cut flowers, in particular apples and kiwis.

According to one specific embodiment, step b) may be carried out continuously or sequentially.

According to this specific embodiment, when the concentration of ethylene in the gaseous atmosphere of the closed chamber is greater than the threshold value mentioned above, step b) may be carried out continuously, then when the concentration of ethylene in the gaseous atmosphere of the closed chamber is less than the threshold value step b) may be carried out sequentially. Advantageously, this makes it possible to reduce the energy cost of the process according to the invention and to preserve the service life of the source of ultraviolet radiation and therefore to reduce the economic cost of the process.

Typically, when step b) is carried out continuously, then the operation of the source of ultraviolet radiation is continuous.

Typically, when step b) is carried out sequentially, then the operation of the source of ultraviolet radiation is characterized by an alternation between periods of turning on and turning off of the source of radiation.

According to one particular embodiment, during step b), the source of ultraviolet radiation emits ultraviolet radiation, the spectral range of which is from 150 nm to 200 nm, very particularly from 160 nm to 180 nm, more particularly from 165 nm to 175 nm.

According to one specific embodiment, during step b), the source of ultraviolet radiation emits ultraviolet radiation, the wavelength of which is 172 nm.

The ethylene absorption spectrum has an absorption maximum at 170 nm. Advantageously, the spans of spectral range and wavelength mentioned above enable a photochemical degradation of the ethylene with a high quantum efficiency during step b) of the process.

Typically, the duration of the treatment step b) is from 0.01 s to 36 000 s, in particular from 0.05 s to 18 000 s, very particularly from 0.10 s to 60 s, more particularly still from 0.15 s to 0.35 s.

Advantageously, a treatment time within the ranges mentioned above makes it possible to effectively treat the gaseous atmosphere drawn off in step a).

The treated gaseous atmosphere is then introduced continuously or sequentially during step c) into the closed chamber.

Thanks to the repetition of the cycle comprising the steps a), b and c), the concentration of ethylene in the gaseous atmosphere of the closed chamber will decrease until a threshold value is reached (transient state) then stabilize at this threshold value (steady state). Typically, this threshold value is less than 5 ppm, in particular less than 2 ppm, more particularly less than 1 ppm, and more particularly still less than 0.03 ppm. These low values are particularly suitable for preserving climacteric fruits and cut flowers, in particular apples and kiwis.

According to one particular embodiment, during the transient state, the steps a), b) and c) may be carried out continuously. This makes it possible to accelerate the decrease in the concentration of ethylene in the gaseous atmosphere of the closed chamber.

According to one particular embodiment, during the steady-state, the steps a), b) and c) may be carried out sequentially as a function of the concentration of ethylene in the gaseous atmosphere of the closed chamber.

According to this particular embodiment, if the concentration of ethylene in the gaseous atmosphere of the closed chamber is less than 10% of the threshold value, in particular 5% of the threshold value, more particularly 1% of the threshold value, then the steps a), b) and c) are not carried out, and if the concentration of ethylene in the gaseous atmosphere of the closed chamber is greater than 10% of the threshold value, in particular 5% of the threshold value, more particularly 1% of the threshold value, then the steps a), b) and c) are carried out in order to reduce the concentration of ethylene in the gaseous atmosphere of the closed chamber.

This particular embodiment makes it possible to reduce the energy cost of the process according to the invention, which is advantageous during the prolonged implementation (over several months) of the process according to the invention.

This process for photochemical treatment of a gaseous atmosphere comprising ethylene may typically be carried out by the reactor 1 according to the first aspect of the invention and as described above.

When the process for photochemical treatment of a gaseous atmosphere comprising ethylene is carried out by the reactor 1, this process comprises:
between steps a) and b), a step a1) of introducing the gaseous atmosphere comprising ethylene into the reactor 1 via the gas inlet port 5, and
between steps b) and c), a step b1) of extracting the treated gaseous atmosphere via the gas outlet port 6.

If the reactor 1 comprises the ozone elimination module, then this module is fluidically connected to the gas outlet port 6 and to the closed chamber and the process comprises, between steps b1) and c), a step b2) of eliminating the ozone produced by the photochemical degradation of ethylene during step b).

Advantageously, this elimination step b2) makes it possible to control the concentration of ozone in the treated gaseous atmosphere which is introduced into the closed chamber during step c).

Typically, the concentration of ozone in the treated gaseous atmosphere which is introduced into the closed chamber during step c) is less than 2 ppm, in particular less than 1 ppm, very particularly from 0.2 ppm to 0.5 ppm.

If the closed chamber is a storage room, in particular a room for storing climacteric fruits, this advantageously makes it possible to benefit from the advantages of the presence of ozone in the closed chamber (sanitary effect on the spores present at the surface of the fruits) without having the drawbacks thereof (problems of safety and of damaging of equipment in the closed chamber).

Typically, the flow rate of gaseous atmosphere in the internal reaction space 4 of the reactor 1 is from 5 m³/h to 2000 m³/h, in particular from 30 m³/h to 1500 m³/h, very particularly from 50 m³/h to 1000 m³/h, and more particularly still from 60 m³/h to 150 m³/h.

Advantageously, a flow rate in the ranges mentioned above makes it possible to effectively treat a large volume of the gaseous atmosphere in the internal reaction space 4 of the reactor 1.

Typically, the residence time in the internal reaction space 4 of the reactor 1 is from 0.05 s to 60 s, in particular from 0.10 s to 25 s, very particularly from 0.15 s to 0.35 s.

Advantageously, a residence time in the ranges mentioned above makes it possible to effectively treat the gaseous atmosphere introduced into the reactor 1.

### EXAMPLES

### Example 1: Experiment of a Photochemical Degradation of Ethylene in an Experimental Room

The feasibility of the photochemical degradation of ethylene in the far UV was firstly validated in an experimental storage room.

The ethylene degradation reactor 1 used is represented in the diagram of FIG. 1. It comprises a side wall 2 having a right circular cylindrical shape along the axis of revolution (Ox) and two end walls 3a and 3b, the side wall 2 and the end walls 3a and 3b delimiting an internal reaction space 4. The reactor 1 further comprises a gas inlet port 5 and a gas outlet port 6, and a source of ultraviolet radiation 7 in the internal reaction space 4. The gap is 39 mm.

The source of ultraviolet radiation 7 is a xenon excimer lamp emitting radiation with a wavelength of 172 nm and having a variable power of from 10 W to 100 W.

The reactor 1 is fluidically connected, via the gas inlet port 5 and the gas outlet port 6, to the experimental storage room, the gaseous atmosphere of which initially comprises 11.5 ppm of ethylene.

a) Experimental Conditions

The temperature in the experimental storage room is 2° C. and the initial composition of the gaseous atmosphere of the experimental storage room is the following:
N₂: 97.33%;
O₂: 1.22%;
CO₂: 0.77%;
H₂O: 95% relative humidity
Ethylene: 11.5 ppm.

The storage room contains 17 tonnes of apples.

Over the entire duration of the experiment, the gaseous atmosphere comprising ethylene is drawn off continuously from the experimental storage room and introduced into the reaction space 4 of the reactor 1 via the gas inlet port 5. The photochemical degradation of ethylene in the reaction space 4 is carried out by the source of ultraviolet radiation 7. The treated gaseous atmosphere is then drawn off from the reaction space 4 via the gas outlet port 6 and reintroduced into the experimental storage room.

The concentration of ethylene in the gaseous atmosphere of the experimental storage room is measured and monitored continuously over the entire duration of the experiment. For this, 500 μl of gaseous atmosphere is drawn off from the experimental storage room every 18 min and its composition is analyzed by a gas chromatograph with injection loop (Airmo VOC C2-C6, Chromatotec®; FID detector, PLOT Al₂O₃/Na₂SO₄ 0.53 mm diameter column).

The power of the lamp is set at 20 W. The flow rate for introducing the gaseous atmosphere into the reactor 1 is 145 m³/h. The residence time in the reaction space 4 of the reactor 1 is 0.15 s.

The experiment is carried out according to two lighting modes of the lamp:
continuous lighting mode: the lamp is switched on for 24 h, and
sequential lighting mode (performed using a programmer that controls the lamp): after the 24 h of the continuous mode, the lamp is switched off for 2 h then switched on for 1 h, the sequence is repeated eight times before turning off the lamp.

b) Experimental Results

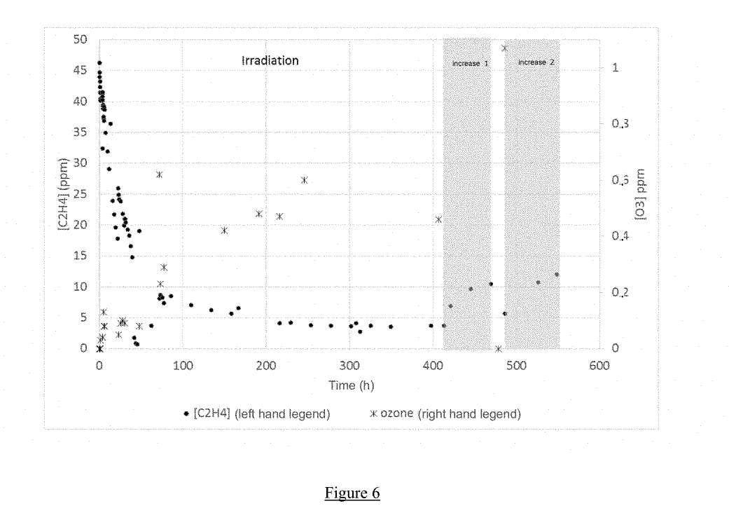

The experimental results are illustrated in FIG. 5.

During the continuous lighting mode, the variation of the concentration of ethylene in the gaseous atmosphere of the experimental storage room may be divided into two states:
a transient state with a very rapid reduction in the ethylene concentration, in less than 10 h, to reach a threshold value close to 0.1 ppm,
a steady state, between 10 h and 24 h (end of the continuous mode), with a stability of the ethylene concentration around the threshold value close to 0.1 ppm.

During the sequential lighting mode:
when the lamp is switched off, the concentration of ethylene in the gaseous atmosphere of the experimental storage room increases and reaches a value greater than 0.8 ppm;
when the lamp is switched on, the concentration of ethylene in the gaseous atmosphere of the experimental storage room decreases very rapidly to around 0.2 ppm; even though this value is greater than the value in continuous lighting mode, it is perfectly satisfactory; and
the maximum value of the concentration of ethylene in the gaseous atmosphere of the experimental storage room increases during the first five repetitions then stabilizes at 1 ppm.

### Example 2: Experiment of a Photochemical Degradation of Ethylene in an Industrial Storage Room

The reactor 1 from Example 1 is fluidically connected, via the gas inlet port 5 and the gas outlet port 6, to a 1000 m³ industrial storage room, the gaseous atmosphere of which initially comprises between 45 ppm and 50 ppm of ethylene.

a) Experimental Conditions

The temperature in the industrial storage room is 0.4° C. and the initial composition of the gaseous atmosphere of the closed chamber is the following:
N₂: 97.8%;
O₂: 1.2%;
CO₂: 1.0%;
H₂O: 95% relative humidity
Ethylene: 45-50 ppm.

The storage room contains 17 tonnes of apples.

Over the entire duration of the experiment, the gaseous atmosphere comprising ethylene is drawn off continuously from the industrial storage room and introduced into the reaction space 4 of the reactor 1 via the gas inlet port 5. The photochemical degradation of ethylene in the reaction space 4 is carried out by the source of ultraviolet radiation 7. The treated gaseous atmosphere is then drawn off from the reaction space 4 via the gas outlet port 6 and reintroduced into the industrial storage room.

The concentration of ethylene in the gaseous atmosphere of the industrial storage room is measured and monitored continuously over the entire duration of the experiment. For this, 250 ml of gaseous atmosphere is drawn off from the industrial storage room and the concentration of ethylene in the gaseous atmosphere drawn off is measured by an electrocatalytic sensor. The sensor is composed of a nanoporous nafion membrane covered with a layer of gold, the oxidation of the ethylene on the membrane releases protons thus making it possible to measure an electric current in the sensor that is proportional to the ethylene concentration.

The power of the lamp is set at 20 W. The flow rate for introducing the gaseous atmosphere into the reactor 1 is 101.5 m³/h. The residence time in the reaction space 4 of the reactor 1 is 0.15 s.

The experiment is carried out according to two lighting modes of the lamp:
continuous lighting mode: the lamp is switched on for 410 h, and
sequential lighting mode (performed using a programmer that controls the lamp): after the 410 h of the continuous mode, the lamp is switched off for 60 h then switched on for 20 h, the sequence is repeated twice.

b) Experimental Results

The experimental results are illustrated in FIG. 6.

During the continuous lighting mode, the variation of the concentration of ethylene in the gaseous atmosphere of the industrial storage room may be divided into two states:
a transient state with a very rapid reduction in the concentration of ethylene in the gaseous atmosphere of the industrial storage room, in 250 h, to reach a threshold value of 3.6 ppm,
a steady state, between 250 h and 410 h (end of the continuous mode), with a stability of the concentration of ethylene in the gaseous atmosphere of the industrial storage room around the threshold value of 3.6 ppm.

During the sequential lighting mode:
when the lamp is switched off, the concentration of ethylene in the gaseous atmosphere of the industrial storage room increases to 10 ppm;
when the lamp is switched on, the concentration of ethylene in the gaseous atmosphere of the industrial storage room decreases very rapidly to around 5 ppm.

Throughout the experiment, the concentration of ozone in the gaseous atmosphere of the industrial storage room is also monitored. As illustrated in FIG. 6, it is always less than 1 ppm and it decreases when the lamp is switched off.

### Example 3: Experiment of a Photochemical Degradation of Ethylene in an Industrial Storage Room Containing Apples for 8 Months

The reactor 1 from Example 1 is fluidically connected, via the gas inlet port 5 and the gas outlet port 6, to an industrial storage room having a capacity of 94 000 m³ (16 tonnes).

17 000 kg of apples (Royal Gala variety) are stored in the industrial storage room.

During the 8 months of the experiment, the temperature in the storage room is maintained between 0.5° C. and 1° C. and the gaseous atmosphere of the storage room is controlled so as to comprise around 1% O₂, around 0.9% CO₂, around 97% N₂ and to have 95% relative humidity.

Over the entire duration of the experiment, the gaseous atmosphere comprising ethylene is drawn off continuously from the industrial storage room and introduced into the reaction space 4 of the reactor 1 via the gas inlet port 5. The photochemical degradation of ethylene in the reaction space 4 is carried out by the source of ultraviolet radiation 7. The treated gaseous atmosphere is then drawn off from the reaction space 4 via the gas outlet port 6 and reintroduced into the industrial storage room.

The concentration of ethylene in the gaseous atmosphere of the industrial storage room is measured and monitored continuously over the entire duration of the experiment according to the protocol described in Example 2.

After a rapid decrease, the concentration of ethylene in the gaseous atmosphere of the industrial storage room is maintained below 0.15 ppm for 8 months.

### Example 4: Experiment of a Photochemical Degradation of Ethylene in an Industrial Storage Room Containing Kiwis for 2 Months

The reactor 1 from Example 1 is fluidically connected, via the gas inlet port 5 and the gas outlet port 6, to an industrial storage room having a capacity of 94 000 m³ (16 tonnes).

243 tonnes of kiwis (Hayward green kiwi variety) are stored in the industrial storage room.

During the 2 months of the experiment, the temperature in the storage room is maintained between 0.5° C. and 1° C. and the gaseous atmosphere of the storage room is controlled so as to comprise around 2.5% O₂, around 3.5% CO₂, around 94% N₂ and to have 95% relative humidity.

Over the entire duration of the experiment, the gaseous atmosphere comprising ethylene is drawn off continuously from the industrial storage room and introduced into the reaction space 4 of the reactor 1 via the gas inlet port 5. The photochemical degradation of ethylene in the reaction space 4 is carried out by the source of ultraviolet radiation 7. The treated gaseous atmosphere is then drawn off from the reaction space 4 via the gas outlet port 6 and reintroduced into the industrial storage room. The concentration of ethylene in the gaseous atmosphere of the industrial storage room is measured and monitored continuously over the entire duration of the experiment according to the protocol described in Example 2.

The concentration of ethylene in the gaseous atmosphere of the industrial storage room is maintained below 0.015 ppm for 2 months.

1. A reactor comprising:
a side wall having a cylindrical shape along an axis of revolution (Ox) and two end walls, the side wall and the end walls delimiting an internal reaction space,
a gas inlet port and a gas outlet port, and
a source of ultraviolet radiation in the internal reaction space,
wherein
the source of ultraviolet radiation emits radiation in the far ultraviolet and has a variable power, in particular from 10 W to 500 W.

2. The reactor (1) according to claim 1, in which the side wall has a right cylindrical shape.

3. The reactor according to claim 2, in which the distance along a transverse axis of the reactor, referred to as a gap, between the source of ultraviolet radiation and the side wall is from 1 mm to 499 mm.

4. The reactor according to claim 1, in which the gas inlet port comprises a part formed by a cylindrical duct, a generatrix of which is tangent to a cross section of the side wall.

5. The reactor according to claim 1 further comprising a programmer suitable for varying the power of the source of ultraviolet radiation.

6. The reactor according to claim 1 comprising n sources of ultraviolet radiation positioned along the axis of revolution (Ox) of the reactor, n being an integer greater than or equal to 2.

7. The reactor according to claim 1 comprising m sources of ultraviolet radiation in a plane (O, y, z) orthogonal to the axis of revolution (Ox), m being an integer greater than or equal to 2.

8. A unit comprising the reactor as defined according to claim 1 and a storage room, the storage room being fluidically connected to the gas inlet port and to the gas outlet port of the reactor.

9. (canceled)

10. (canceled)

11. A process for photochemical treatment of a gaseous atmosphere of a closed chamber comprising ethylene, said process comprising at least one cycle comprising the following steps:
a) drawing off the gaseous atmosphere from the closed chamber,
b) treating the gaseous atmosphere to obtain a treated gaseous atmosphere,
c) introducing the treated gaseous atmosphere into the closed chamber,
wherein the treatment step b) is a step of photochemical degradation of the ethylene carried out by a source of ultraviolet radiation emitting radiation in the far ultraviolet and having a variable power, in particular from 10 W to 500 W.

12. The process according to claim 11, in which the concentration of ethylene in the treated gaseous atmosphere is less than 5 ppm.

13. The process according to claim 11 implemented by the reactor as defined according to claim 1.

14. The process according to claim 13 comprising:
between steps a) and b), a step a1) of introducing the gaseous atmosphere comprising ethylene into the reactor via the gas inlet port, and
between steps b) and c), a step b1) of extracting the treated gaseous atmosphere via the gas outlet port.

15. A process according to claim 14 in which the residence time in the internal reaction space of the reactor is from 0.05 s to 60 s.
